(19) United States
(12) Patent Application Publication
(10) Pub. No.: US 2019/0284868 A1
(43) Pub. Date: Sep. 19, 2019

(54) MULTIPLE GLAZING

(71) Applicant: SAINT-GOBAIN GLASS FRANCE, Courbevoie (FR)

(72) Inventors: Jean-Philippe SCHWEITZER, Chamant (FR); Nicolas NADAUD, Paris (FR)

(73) Assignee: SAINT-GOBAIN GLASS FRANCE, Courbevoie (FR)

(21) Appl. No.: 16/345,103

(22) PCT Filed: Oct. 20, 2017
(86) PCT No.: PCT/FR2017/052888

§ 371 Date: Apr. 25, 2019

(30) Foreign Application Priority Data
Oct. 26, 2016 (FR) 1660382

(51) Int. Cl. E06B 3/67; C03C 17/36

(52) U.S. Cl. CPC E06B 3/6715; C03C 17/3639; C03C 17/3681; C03C 17/366; C03C 17/3644

(57) ABSTRACT

A multiple glazing includes a plurality of parallel panes separated by at least one spacer delimiting at least one interlayer space between the panes, the glazing being such that one at least of the panes, “functional pane”, includes at least one thin glass sheet, not thermally tempered, the thickness ti of which is within a range extending from 0.1 to 2 mm and at least one of the faces of which is coated with a stack of thin layers having a low emissivity including at least one silver layer, the stack exhibiting a sheet resistance Rs, expressed in ohms, corresponding to the formula:

Rs·t₂²−115·n<25·t₂,

t₂ being the thickness of the silver layer or the sum of the thicknesses of each silver layer present in the stack and n being the number of silver layers present in the stack.

The invention relates to the field of glazings, more particularly multiple glazings.

Multiple requirements, sometimes contradictory, are placed on multiple glazings. The latter have to exhibit excellent thermal insulation properties, preventing as much as possible any loss of heat by convection, conduction or radiation. At the same time, the solar factor of the glazing has to maximized, in order for the solar radiation to be able to heat the inside of the building. Finally, the glazing has to be as light as possible, in particular in order to facilitate the handling thereof, but while ensuring an excellent thermomechanical strength, in order to prevent any breakage, either during installation or during use.

It is an aim of the invention to provide a glazing which meets, as best as possible, these different requirements.

To this end, a subject matter of the invention is a multiple glazing comprising a plurality of parallel panes separated by at least one spacer delimiting at least one interlayer space between said panes, said glazing being such that one at least of said panes, “functional pane”, comprises at least one thin glass sheet, not thermally tempered, the thickness t1 of which is within a range extending from 0.1 to 2 mm and at least one of the faces of which is coated with a stack of thin layers having a low emissivity comprising at least one silver layer, said stack exhibiting a sheet resistance Rs, expressed in ohms, corresponding to the formula:

Rs·t2²−115·n<25·t2,

t₂ being, expressed in nm, the thickness of the silver layer or the sum of the thicknesses of each silver layer present in the stack and n being the number of silver layers present in the stack.

A stack having a low emissivity or also “low-e” stack is, within the meaning of the invention, a stack whose normal emissivity at 283 K within the meaning of the standard EN 12898 is generally at most 0.05, in particular 0.03 and even 0.02 or 0.01.

According to specific embodiments, the glazing additionally comprises one or more of the following optional characteristics, taken in isolation or according to all the combinations technically possible:
the or each pane comprises at least one glass sheet, indeed even consists of a glass sheet, which is in particular transparent or translucent.
the thickness t1 is within a range extending from 0.5 to 1.6 mm, indeed even from 1.0 to 1.5 mm, or within a range extending from 0.2 to 0.9 mm.
the at least one face coated with a stack having a low emissivity is turned toward an interlayer space. The stack is thus protected from chemical or mechanical attacks.
just one of the faces or the or each thin glass sheet is coated with a stack of thin layers having a low emissivity.
the glazing comprises only one functional pane.
the glazing comprises at least two functional panes, in particular exactly two or three functional panes.
the glazing is a double glazing. It thus preferably comprises two single panes separated by a single spacer delimiting a single interlayer space. At least one of these panes, in particular just one, or each of these panes is then a functional pane.
the glazing comprises at least three panes, in particular comprises exactly three panes. It can, for example, be a triple or quadruple glazing. According to a first embodiment, the glazing comprises p panes separated in pairs by (p−1) spacers each delimiting a single interlayer space. According to a second embodiment, the glazing advantageously comprises a single spacer fixed between two “external” panes and provided with at least one peripheral groove each receiving an “internal” pane located between said external panes. The glazing comprises in particular exactly three panes; it is then a triple glazing. Preferably, this triple glazing comprises a single spacer fixed between the two external panes and provided with just one peripheral groove receiving a single internal pane located between said external panes.
the or each peripheral groove is provided with a lining based on elastomer material, for example an ethylene/propylene/diene (EPDM) rubber. The lining serves to fix the internal pane in the groove, while making it possible to compensate for possible variations in thermal expansion of the internal pane. Stress-free fixing of the internal pane in the groove is thus provided, making it possible to provide the glazing with excellent thermomechanical strength, even when the internal pane is a functional pane within the meaning of the present invention.
at least one internal pane is a functional pane. In the case of a triple glazing, the internal pane is then a functional pane. Preferably, the internal pane is the only functional pane of the glazing. The thickness of the external panes is preferably within a range extending from 2 to 6 mm, in particular from 2 to 4 mm.
the or each functional pane consists of just one glass sheet, thus of a thin glass sheet as defined above.
the or each functional pane comprises at least two glass sheets, in particular exactly two glass sheets. Preferably, at least one thin glass sheet is adhesively fixed to another glass sheet by means of a lamination interlayer, such as polyvinyl butyral (PVB). The thin glass sheet is, in this case, preferably in contact with an interlayer space. The other glass sheet is preferably thin, in the sense that its thickness is within a range extending from 0.1 to 2 mm, in particular from 0.5 to 1.6 mm. This other glass sheet may or may not be coated with a stack of thin layers.
at least one pane of the glazing is not a functional pane. The thickness of the nonfunctional panes is preferably within a range extending from 2 to 6 mm, in particular from 2 to 4 mm. At least one nonfunctional pane can be coated on one at least of its faces, in particular on the face turned toward an interlayer space, with a stack of thin low-e layers which is identical to or different from that carried by the thin glass sheet of the functional pane. At least one nonfunctional pane can be coated on one at least of its faces with a stack of thin layers exhibiting other functions, in particular solar control, anticondensation or self-cleaning functions.
the or each stack of thin layers having a low emissivity comprises one, two, three or four silver layers (n=1, 2, 3 or 4). As explained in more detail in the continuation of the text, the or each silver layer is preferably framed by at least two coatings each comprising at least one dielectric layer.
the or each stack having a low emissivity is obtained by a process comprising a stage of deposition, in particular by magnetron cathode sputtering, of said stack, followed by a stage of rapid annealing of said stack, in particular by means of laser radiation or of a flash lamp. Further details with regard to these techniques are given in the continuation of the text.
the or each thin glass sheet is obtained by floating or by drawing, in particular by drawing downward, especially by the “fusion-draw” process.

The characteristics and advantages of the invention will become apparent in the description which will follow of several embodiments of a multiple glazing according to the invention, given solely by way of example and made with reference to the appended drawings, in which:

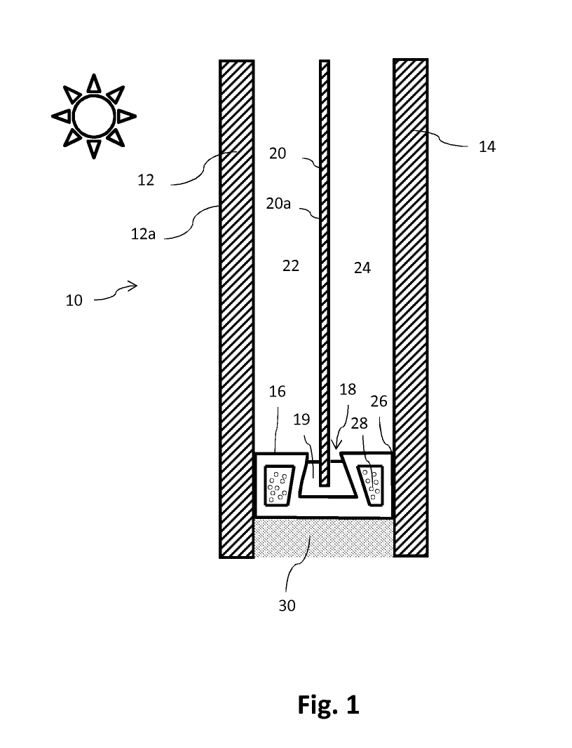

FIG. 1 illustrates a triple glazing, seen in section.

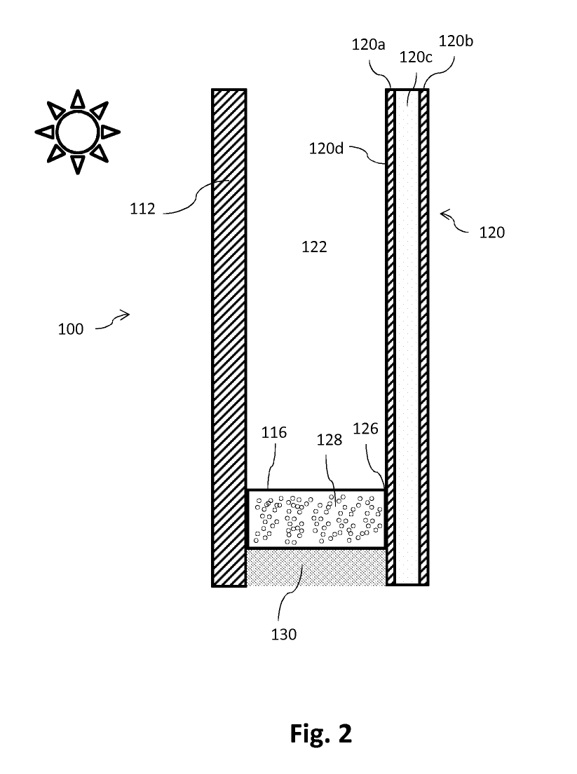

FIG. 2 illustrates a double glazing, seen in section.

FIG. 1 illustrates a triple glazing 10 according to the invention comprising two external panes, respectively a first pane 12 intended to be turned toward the outside of a building and a second pane 14 typically intended to be turned toward the inside of the building. These two external panes are fixed to a spacer 16 extending continuously along the edge of the external panes 12 and 14. The spacer 16 is provided with a peripheral groove 18 receiving an internal pane 20 located between said external panes 12 and 14.

As is usual, the faces of the panes are named by numbers ranging from 1 to 6, by increasing order starting from the external face 12a of the external pane 12, in contact with the outside, which is the face 1.

The two external panes 12 and 14 comprise glass sheets. They can, for example, be monolithic glass sheets with a thickness within a range extending from 2 to 6 mm, in particular from 3 to 5 mm. They can also, in particular for the external pane 12 intended to be turned toward the outside of the building, be an assemblage of two glass sheets adhesively bonded by a lamination interlayer, for example made of polyvinyl butyral (PVB), this being done in order to confer anti-break-in and/or sound insulation and/or personnel-safety (for example shatterproof) properties.

The different faces of the external panes 12 and 14 may or may not be coated with stacks of thin layers conferring various functionalities on the glazing 10. For example, the external face 12a of the external pane 12 can be coated with a self-cleaning stack containing at least one photocatalytic layer, in particular of titanium oxide, in particular at least partially crystallized in the anatase form, and/or with an anticondensation stack comprising at least one layer having a low emissivity, such as a layer of a transparent conductive oxide (TCO), in particular of indium tin oxide (ITO) or of doped zinc oxide. The other faces of the external panes 12 and 14 can be coated with stacks of thin layers having a low emissivity comprising at least one silver layer.

The spacer 16 can be formed of metal and/or of polymer material. Examples of suitable metal materials comprise in particular aluminum or stainless steel. Examples of suitable polymer materials comprise in particular polyethylene (PE), polycarbonate (PC), polypropylene (PP), polystyrene, polybutadiene, polyesters, polyurethanes, polymethyl methacrylate, polyacrylates, polyamides, polyethylene terephthalate (PET), polybutylene terephthalate (PBT), acrylonitrile/butadiene/styrene (ABS), acrylonitrile/styrene/acrylate (ASA) or styrene/acrylonitrile copolymer(SAN). Any combination or mixture of these materials can also be envisaged; for example, each profiled element of the spacer can be based on polypropylene comprising a reinforcement consisting of a stainless steel sheet. When it is based on polymer material, the profiled element is advantageously reinforced by fibers, in particular glass or carbon fibers.

The groove 18 is provided with a lining 19 based on elastomer material, typically an ethylene/propylene/diene (EPDM) rubber. The thermomechanical strength of the glazing is found to be improved thereby, despite the use as internal pane of a thin glass sheet not tempered thermally.

The assembly formed by the external panes 12, 14, the spacer 16 and the internal pane 20 forms two interlayer spaces 22 and 24. Each interlayer space 22, 24 can be filled with air. However, preferably, each interlayer space 22, 24 comprises a band of an insulating gas, which will replace air between the panes. Examples of gases used to form the band of insulating gas in each interlayer space of the multiple glazing comprise in particular argon (Ar), krypton (Kr) and xenon (Xe). Advantageously, the band of insulating gas in each interlayer space of the multiple glazing comprises at least 85% of a gas exhibiting a lower thermal conductivity than that of air. Appropriate gases are preferably colorless, nontoxic, noncorrosive, nonflammable and insensitive to exposure to ultraviolet radiation.

In order to render interlayer spaces 22, 24 leaktight, leaktightness strips 26 are positioned between the two external panes 12, 14 and the lateral edges of the spacer 16. The leaktightness strips 26 are, for example, based on polyisobutylene (butyl).

The spacer 16 defines a housing for receiving desiccant material 28 in order to absorb any residual moisture which may be present in the interlayer space 22, 24. The desiccant material 28 can be any material capable of dehydrating the air or the band of gas present in each interlayer space 22, 24 of the multiple glazing 10, chosen in particular from molecular sieve, silica gel, CaCl₂), Na₂SO₄, activated carbon, zeolites and/or a mixture of these.

A sealing barrier 30, for example made of polysulfide resin, is applied to the exterior circumference of the spacer 16, between the external panes 12 and 14, in order to hold the panes 12, 14 on the spacer 16.

The internal pane 20 is a functional pane within the meaning of the present invention. It is a thin glass sheet, the thickness of which is within a range extending from 0.1 to 2 mm and one of the faces 20a of which, which is the face 3 of the glazing, turned toward the interlayer space 22, is coated with a stack of thin layers having a low emissivity. According to other embodiments, which are not represented, the stack can coat the other face of the glass sheet or both faces of the glass sheet.

This stack comprises n silver layers (n having a value, for example, of 1, 2, 3 and the like) and exhibits a sheet resistance Rs, expressed in ohms, corresponding to the formula:

Rs·t2²−115·n<25·t2,

t2 being the thickness of the silver layer or the sum of the thicknesses of each silver layer.

The stack preferably comprises, starting from the substrate, a first coating comprising at least one first dielectric layer, at least one silver layer and optionally an overblocker layer and a second coating comprising at least one second dielectric layer.

Preferably, the physical thickness of the or each silver layer is between 6 and 20 nm.

The overblocker layer is intended to protect the silver layer during the deposition of a subsequent layer (for example if the latter is deposited under an oxidizing or nitriding atmosphere) and during an optional heat treatment of the tempering or bending type.

The silver layer can also be deposited on and in contact with an underblocker layer. The stack can thus comprise an overblocker layer and/or an underblocker layer flanking the or each silver layer.

The blocker (underblocker and/or overblocker) layers are generally based on a metal chosen from nickel, chromium, titanium, niobium or an alloy of these different metals. Mention may in particular be made of nickel/titanium alloys (in particular those comprising approximately 50% by weight of each metal) or nickel/chromium alloys (in particular those comprising 80% by weight of nickel and 20% by weight of chromium). The overblocker layer can also consist of several superimposed layers, for example, on moving away from the substrate, of titanium and then of a nickel alloy (in particular a nickel/chromium alloy), or vice versa. The different metals or alloys cited can also be partially oxidized and can in particular be substoichiometric in oxygen (for example TiOₓ or NiCrOₓ).

These blocker (underblocker and/or overblocker) layers are very thin, normally with a thickness of less than 1 nm, so as not to affect the light transmission of the stack, and are capable of being partially oxidized during the heat treatment according to the invention.

Generally, the blocker layers are sacrificial layers capable of capturing oxygen originating from the atmosphere or from the substrate, thus preventing the silver layer from oxidizing.

The first and/or the second dielectric layer is typically made of oxide (in particular made of tin oxide) or preferably made of nitride, in particular made of silicon nitride (especially for the second dielectric layer, the one furthest from the substrate). Generally, the silicon nitride can be doped, for example with aluminum or boron, in order to facilitate its deposition by cathode sputtering techniques. The degree of doping (corresponding to the atomic percentage with respect to the amount of silicon) generally does not exceed 2%. The function of these dielectric layers is to protect the silver layer from chemical or mechanical attacks and they also influence the optical properties, in particular in reflection, of the stack, by virtue of interference phenomena.

The first coating can comprise a dielectric layer or several, typically from 2 to 4, dielectric layers. The second coating can comprise a dielectric layer or several, typically 2 or 3, dielectric layers. These dielectric layers are preferably made of a material chosen from silicon nitride, titanium oxide, tin oxide or zinc oxide, or any one of their mixtures or solid solutions, for example a tin zinc oxide or a titanium zinc oxide. Whether in the first coating or in the second coating, the physical thickness of the dielectric layer or the overall physical thickness of all of the dielectric layers is preferably between 15 and 60 nm, in particular between 20 and 50 nm.

The first coating preferably comprises, immediately under the silver layer or under the optional underblocker layer, a wetting layer, the function of which is to increase the wetting and bonding of the silver layer. Zinc oxide, in particular doped with aluminum, has proved to be particularly advantageous in this regard.

The first coating can also contain, directly under the wetting layer, a smoothing layer, which is a partially, indeed even completely, amorphous mixed oxide (thus of very low roughness), the role of which is to promote the growth of the wetting layer according to a preferred crystallographic orientation, which promotes the crystallization of the silver by epitaxy phenomena. The smoothing layer is preferably composed of a mixed oxide of at least two metals chosen from Sn, Zn, In, Ga and Sb. A preferred oxide is antimony-doped indium tin oxide.

In the first coating, the wetting layer or the optional smoothing layer is preferably deposited directly on the first dielectric layer. The first dielectric layer is preferably deposited directly on the substrate. For optimal adaptation of the optical properties of the stack (in particular the appearance in reflection), the first dielectric layer can alternatively be deposited on another oxide or nitride layer, for example a titanium oxide layer.

Within the second coating, the second dielectric layer can be deposited directly on the silver layer or preferably on an overblocker, or also on other oxide or nitride layers intended for adapting the optical properties of the stack. For example, a zinc oxide layer, in particular doped with aluminum, or also a tin oxide layer, can be positioned between an overblocker and the second dielectric layer, which is preferably made of silicon nitride. Zinc oxide, in particular doped with aluminum, makes it possible to improve the adhesion between the silver and the upper layers.

Thus, the stack preferably comprises at least one ZnO/Ag/ZnO sequence. The zinc oxide can be doped with aluminum. An underblocker layer can be positioned between the silver layer and the underlying layer. Alternatively or cumulatively, an overblocker layer can be positioned between the silver layer and the overlying layer.

Finally, the second coating can be surmounted by an overlayer, sometimes referred to as an “overcoat” in the art. The final layer of the stack, and thus the one in contact with the ambient air, it is intended to protect the stack from any mechanical attack (scratches, and the like) or chemical attack. This overcoat is generally very thin so as not to disturb the appearance in reflection of the stack (its thickness is typically between 1 and 5 nm). It is preferably based on titanium oxide or on mixed tin zinc oxide, in particular doped with antimony, deposited in substoichiometric form.

The stack can comprise one or more silver layers, in particular two or three silver layers. When several silver layers are present, the general architecture presented above can be repeated. In this case, the second coating relative to a given silver layer (thus located above this silver layer) generally coincides with the first coating relative to the following silver layer.

In this instance, the stack is obtained by magnetron cathode sputtering. Other deposition techniques are also possible, such as, for example, the plasma-enhanced chemical vapor deposition (PECVD) technique.

In order to achieve an extremely low resistivity and an extremely low emissivity, the silver layers have to exhibit a high degree of crystallization, which cannot be obtained during the deposition, with the result that a heat treatment proves to be necessary. Conventionally, the glass is heat tempered, that is to say that it is brought to a temperature of approximately 600° C. to 630° C., and then suddenly cooled. Besides the improvement in the resistivity and emissivity properties of the silver layers, the heat tempering makes it possible to improve the thermomechanical strength of the pane. However, the heat tempering cannot be carried out industrially for thin glass sheets.

The excellent resistivity and emissivity properties of the stack are in this instance obtained by a stage of rapid annealing, in particular by means of laser radiation or of a flash lamp.

The term “rapid annealing” is understood to mean a treatment capable of bringing each point of the stack to be treated to temperatures typically of 300° C. and more, for a very short time, typically of less than 10 seconds, in particular 1 second, indeed even 0.1 second. The heat does not have the time to diffuse into the glass sheet, with the result that the temperature of the glass sheet generally does not exceed a temperature of 50° C.

According to a preferred embodiment, the rapid annealing is carried out by means of a flash lamp.

Flash lamps are generally provided in the form of sealed glass or quartz tubes filled with a rare gas and provided with electrodes at their ends. Under the effect of an electric pulse of short duration, obtained by discharge of a capacitor, the gas ionizes and produces a particularly intense incoherent light. The emission spectrum generally comprises at least two emission lines; it is preferably a continuous spectrum exhibiting an emission maximum in the near ultraviolet.

The lamp is preferably a xenon lamp. It can also be an argon, helium or krypton lamp. The emission spectrum preferably comprises several lines, in particular at wavelengths ranging from 160 to 1000 nm.

The duration of the flash is preferably within a range extending from 0.05 to 20 milliseconds, in particular from 0.1 to 5 milliseconds. The repetition rate is preferably within a range extending from 0.1 to 5 Hz, in particular from 0.2 to 2 Hz.

The radiation can result from several lamps positioned side by side, for example from 5 to 20 lamps, or also from 8 to 15 lamps, so as to simultaneously treat a wider area. All the lamps can in this case emit flashes simultaneously.

The or each lamp is preferably positioned transversely to the largest sides of the substrate. The or each lamp has a length preferably of at least 1 m, in particular 2 m and even 3 m, so as to be able to treat large-sized substrates.

The capacitor is typically charged at a voltage of 500 V to 500 kV. The current density is preferably at least 4000 A/cm². The density of total energy emitted by the flash lamps, with respect to the surface area of the stack, is preferably between 1 and 100 J/cm², in particular between 1 and 30 J/cm², indeed even between 5 and 20 J/cm².

According to another preferred embodiment, the rapid annealing is carried out by means of laser radiation. The laser radiation is preferably focused on the stack in the form of at least one laser line.

The laser radiation is preferably generated by modules comprising one or more laser sources and also forming and redirecting optics.

The laser sources are typically laser diodes or fiber lasers, in particular fiber, diode or also disk lasers. Laser diodes make it possible to economically achieve high power densities, with respect to the electrical supply power, for a small space requirement. The space requirement of fiber lasers is even smaller, and the linear power density obtained can be even higher, for a cost, however, which is greater. The term “fiber lasers” is understood to mean lasers in which the place where the laser light is generated is spatially removed from the place to which it is delivered, the laser light being delivered by means of at least one optical fiber. In the case of a disk laser, the laser light is generated in a resonator cavity in which the emitting medium, which is in the form of a disk, for example a thin disk (approximately 0.1 mm thick) made of Yb:YAG, is found. The light thus generated is coupled in at least one optical fiber directed toward the place of treatment. Fiber or disk lasers are preferably optically pumped using laser diodes.

The radiation resulting from the laser sources is preferably continuous.

The wavelength of the laser radiation is preferably within a range extending from 500 to 2000 nm, in particular from 700 to 1100 nm, indeed even from 800 to 1000 nm. High-power laser diodes which emit at one or more wavelengths chosen from 808 nm, 880 nm, 915 nm, 940 nm or 980 nm have proved to be particularly well suited. In the case of a disk laser, the wavelength is, for example, 1030 nm (emission wavelength for a Yb:YAG laser). For a fiber laser, the wavelength is typically 1070 nm.

In the case of non-fiber lasers, the forming and redirecting optics preferably comprise lenses and mirrors, and are used as means for positioning, homogenizing and focusing the radiation.

The purpose of the positioning means is, if appropriate, to arrange, along a line, the radiation emitted by the laser sources. They preferably comprise mirrors. The purpose of the homogenization means is to superimpose the spatial profiles of the laser sources in order to obtain a homogeneous linear power density along the whole of the line. The homogenization means preferably comprise lenses which make possible the separation of the incident beams into secondary beams and the recombination of said secondary beams into a homogeneous line. The radiation-focusing means make it possible to focus the radiation on the stack to be treated, in the form of a line of desired length and width. The focusing means preferably comprise a focusing mirror or a convergent lens.

In the case of fiber lasers, the forming optics are preferably grouped together in the form of an optical head positioned at the outlet of the or each optical fiber.

The forming optics of said optical heads preferably comprise lenses, mirrors and prisms, and are used as means for converting, homogenizing and focusing the radiation.

The converting means comprise mirrors and/or prisms and serve to convert the circular beam, obtained at the outlet of the optical fiber, into an anisotropic non-circular beam, in the shape of a line. For this, the converting means increase the quality of the beam along one of its axes (fast axis, or axis of width w of the laser line) and reduce the quality of the beam along the other (slow axis, or axis of length l of the laser line).

The homogenization means superimpose the spatial profiles of the laser sources in order to obtain a homogeneous linear power density along the whole of the line. The homogenization means preferably comprise lenses which make possible the separation of the incident beams into secondary beams and the recombination of said secondary beams into a homogeneous line.

Finally, the radiation-focusing means make it possible to focus the radiation at the level of the working plane, that is to say in the plane of the stack to be treated, in the form of a line of desired length and width. The focusing means preferably comprise a focusing mirror or a convergent lens.

When a single laser line is used, the length of the line is advantageously equal to the width of the substrate. This length is typically at least 1 m, in particular 2 m and even 3 m. It is also possible to use several lines, separated or not separated, but positioned so as to treat the entire width of the substrate. In this case, the length of each laser line is preferably at least 10 cm or 20 cm, in particular within a range extending from 30 to 100 cm, in particular from 30 to 75 cm, indeed even from 30 to 60 cm.

The term “length” of the line is understood to mean the greatest dimension of the line, measured on the surface of the stack in a first direction, transverse to the direction of forward progression of the substrate, and the term “width” is understood to mean the dimension along a second direction, orthogonal to the first direction. As is customary in the field of lasers, the width w of the line corresponds to the distance (along this second direction) between the axis of the beam (where the intensity of the radiation is at a maximum) and the point where the intensity of the radiation is equal to 1/e² times the maximum intensity. If the longitudinal axis of the laser line is referred to as x, it is possible to define a width distribution along this axis, referred to as w(x).

The mean width of the or each laser line is preferably at least 35 micrometers, in particular within a range extending from 40 to 100 micrometers or from 40 to 70 micrometers. Throughout the present text, the term “mean” is understood to mean the arithmetic mean. Over the entire length of the line, the width distribution is narrow in order to limit as far as possible any treatment heterogeneity. Thus, the difference between the greatest width and the smallest width is preferably at most 10% of the value of the mean width. This figure is preferably at most 5% and even 3%.

The forming and redirecting optics, in particular the positioning means, can be adjusted manually or using actuators which make it possible to adjust their positioning remotely. These actuators (typically piezoelectric motors or blocks) can be controlled manually and/or be adjusted automatically. In the latter case, the actuators will preferably be connected to detectors and also to a feedback loop.

At least a portion of the laser modules, indeed even all of them, are preferably positioned in a leaktight box, which is advantageously cooled, in particular ventilated, in order to ensure their thermal stability.

The laser modules are preferably mounted on a rigid structure, referred to as a “bridge”, based on metal elements, typically made of aluminum. The structure preferably does not comprise a marble slab. The bridge is preferably positioned parallel to the conveying means so that the focal plane of the or each laser line remains parallel to the surface of the substrate to be treated. Preferably, the bridge comprises at least four feet, the height of which can be individually adjusted in order to ensure a parallel positioning under all circumstances. The adjustment can be provided by motors located at each foot, either manually or automatically, in connection with a distance sensor. The height of the bridge can be adapted (manually or automatically), in order to take into account the thickness of the substrate to be treated and to thus ensure that the plane of the substrate coincides with the focal plane of the or each laser line.

The linear power density of the laser line is preferably at least 300 W/cm, advantageously 350 or 400 W/cm, in particular 450 W/cm, indeed even 500 W/cm and even 550 W/cm. It is even advantageously at least 600 W/cm, in particular 800 W/cm, indeed even 1000 W/cm. The linear power density is measured at the place where the or each laser line is focused on the stack. It can be measured by placing a power detector along the line, for example a calorimetric power meter, such as in particular the Beam Finder S/N 2000716 power meter from Coherent Inc. The power is advantageously distributed homogeneously over the entire length of the or each line. Preferably, the difference between the highest power and the lowest power is less than 10% of the mean power.

The energy density provided to the stack is preferably at least 20 J/cm², indeed even 30 J/cm².

The high powers and energy densities make it possible to heat the stack very rapidly, without significantly heating the substrate.

The maximum temperature to which each point of the stack is subjected during the heat treatment is preferably at least 300° C., in particular 350° C., indeed even 400° C., and even 500° C. or 600° C. The maximum temperature is normally undergone at the moment when the point of the stack in question passes under the radiation device, for example under the laser line or under the flash lamp. At a given instant, only the points of the surface of the stack located under the radiation device (for example under the laser line) and in the immediate vicinity thereof (for example less than one millimeter away) are normally at a temperature of at least 300° C. For distances to the laser line (measured along the direction of forward progression) of greater than 2 mm, in particular 5 mm, including downstream of the laser line, the temperature of the stack is normally at most 50° C., and even 40° C. or 30° C.

Each point of the stack is subjected to the heat treatment (or is brought to the maximum temperature) for a period of time advantageously within a range extending from 0.05 to 10 ms, in particular from 0.1 to 5 ms, or from 0.1 to 2 ms. In the case of a treatment by means of a laser line, this period of time is fixed both by the width of the laser line and by the speed of relative displacement between the substrate and the laser line. In the case of a treatment by means of a flash lamp, this period of time corresponds to the duration of the flash.

The laser radiation is partly reflected by the stack to be treated and partly transmitted through the substrate. For safety reasons, it is preferable to position radiation-halting means in the path of this reflected and/or transmitted radiation. These radiation-halting means will typically be metal housings cooled by circulation of fluid, in particular of water. To prevent the reflected radiation from damaging the laser modules, the axis of propagation of the or each laser line forms a preferably non-zero angle with the normal to the substrate, typically an angle of between 5° and 20°.

FIG. 2 illustrates a double glazing 100 according to the invention. The double glazing 100 comprises two external panes, respectively a first pane 112 intended to be turned toward the outside of a building and a second pane 120 typically intended to be turned toward the inside of the building. These two external panes are fixed to a spacer 116 extending continuously along the edge of the external panes 112 and 120.

The two external panes 112 and 120 comprise glass sheets. It can, for example for the external pane 112, be a monolithic glass sheet with a thickness within a range extending from 2 to 6 mm, in particular from 3 to 5 mm.

The spacer 116 can be formed of metal and/or of polymer material, as described above in connection with the spacer 16 of FIG. 1.

The assembly formed by the external panes 112, 120 and the spacer 116 forms an interlayer space 122. This interlayer space 122 can be filled with air. However, preferably, the interlayer space 122 comprises a band of an insulating gas, which will replace air between the panes. Examples of gases have been given above in connection with the interlayer spaces 22 and 24 of FIG. 1.

In order to render the interlayer space 122 leaktight, leaktightness strips 126 are positioned between the two external panes 112, 120 and the lateral edges of the spacer 116. The leaktightness strips 126 are, for example, based on polyisobutylene (butyl).

The spacer 116 defines a housing for receiving desiccant material 128 in order to absorb any residual moisture which may be present in the interlayer space 122. The desiccant material 128 can be any material capable of dehydrating the air or the band of gas present in the interlayer space 122 of the multiple glazing 100, chosen in particular from molecular sieve, silica gel, CaCl₂), Na₂SO₄, activated carbon, zeolites and/or a mixture of these.

A sealing barrier 130, for example made of polysulfide resin, is applied to the exterior circumference of the spacer 116, between the external panes 112 and 120, in order to hold the panes 112, 120 on the spacer 116.

The external pane 120 is a functional pane within the meaning of the present invention. This functional pane 120 is in this instance an assembly of two thin glass sheets 120a, 120b adhesively bonded by a lamination interlayer 120c, for example made of polyvinyl butyral (PVB).

The thickness of the thin glass sheets 120a, 120b is within a range extending from 0.1 to 2 mm.

One of the faces 120d of the sheet 120a, which is the face 3 of the glazing, turned toward the interlayer space 122, is coated with a stack of thin layers having a low emissivity. The various details given above in connection with FIG. 1 with regard to the stack of thin layers having a low emissivity and to the means for obtaining it also apply to the glazing of FIG. 2, as to any type of glazing according to the invention.

1. A multiple glazing comprising a plurality of parallel panes separated by at least one spacer delimiting at least one interlayer space between said panes, said glazing being such that one at least of said panes is a functional pane that comprises at least one thin glass sheet, not thermally tempered, a thickness t₁ of which is within a range extending from 0.1 to 2 mm and at least one of the faces of which is coated with a stack of thin layers having a low emissivity comprising at least one silver layer, said stack exhibiting a sheet resistance Rs, expressed in ohms, corresponding to the formula:
Rs·t₂²−115·n<25·t₂,
t₂ being, expressed in nm, the thickness of the silver layer or the sum of the thicknesses of each silver layer present in the stack and n being the number of silver layers present in the stack.

2. The multiple glazing as claimed in claim 1, such that the thickness t₁ is within a range extending from 0.5 to 1.6 mm.

3. The multiple glazing as claimed in claim 1, such that the at least one face coated with a stack having a low emissivity is turned toward an interlayer space.

4. The multiple glazing as claimed in claim 1, which is a double glazing.

5. The multiple glazing as claimed in claim 1, comprising at least three panes.

6. The multiple glazing as claimed in claim 5, comprising a single spacer fixed between two external panes and provided with at least one peripheral groove each receiving an “internal” pane located between said two external panes.

7. The multiple glazing as claimed in claim 6, such that the or each peripheral groove is provided with a lining based on elastomer material.

8. The multiple glazing as claimed in claim 6, such that at least one internal pane is said functional pane.

9. The multiple glazing as claimed in claim 1, such that at least one thin glass sheet is adhesively fixed to another glass sheet by means of a lamination interlayer.

10. The multiple glazing as claimed in claim 1, such that the or each stack having a low emissivity is obtained by a process comprising a stage of deposition of said stack, followed by a stage of rapid annealing of said stack.

11. The multiple glazing as claimed in claim 5, comprising exactly three panes.

12. The multiple glazing as claimed in claim 10, wherein the stage of deposition is done by magnetron cathode sputtering.

13. The multiple glazing as claimed in claim 10, wherein the stage of rapid annealing of said stack is done by laser radiation or a flash lamp.
